(19) United States
(12) Patent Application Publication
(10) Pub. No.: US 2025/0004711 A1
(43) Pub. Date: Jan. 2, 2025

(54) DATA PROCESSING METHOD AND APPARATUS, DEVICE, AND STORAGE MEDIUM

(71) Applicant: Tencent Technology (Shenzhen) Company Limited, Shenzhen (CN)

(72) Inventor: Zimu REN, Shenzhen (CN)

(73) Assignee: Tencent Technology (Shenzhen) Company Limited, Shenzhen (CN)

(21) Appl. No.: 18/882,351

(22) Filed: Sep. 11, 2024

Related U.S. Application Data
(63) Continuation of application No. PCT/CN2023/134534, filed on Nov. 28, 2023.

(30) Foreign Application Priority Data
Dec. 9, 2022 (CN) 202211584238.4

(51) Int. Cl. G06F 5/01; G06F 7/544

(52) U.S. Cl. CPC G06F 5/012; G06F 7/5443

(57) ABSTRACT

A method includes: performing multiplication on first and second floating-point numbers of a multiply-add operation to obtain a multiplication result; determining an exponent difference between exponents of the multiplication result and a third floating-point number of the multiply-add operation; performing alignment shift on the third floating-point number and/or the multiplication result in response to the exponent difference being less than or equal to a shift amount threshold, to obtain an aligned floating-point number and an alignment multiplication result; calculating an addition result between the aligned floating-point number and the alignment multiplication result by using an adder, and predicting a normalization shift amount for the addition result using a prediction encoder; and performing normalization shift on the addition result according to the predicted normalization shift amount, and obtaining an operation result of the multiply-add operation according to the obtained normalized result.

### RELATED APPLICATION

This application is a continuation of International Patent Application No. PCT/CN2023/134534, filed Nov. 28, 2023, which claims priority to Chinese Patent Application No. 202211584238.4, filed with the China National Intellectual Property Administration on Dec. 9, 2022, and entitled “DATA PROCESSING METHOD AND APPARATUS, DEVICE, AND STORAGE MEDIUM”. The contents of International Patent Application No. PCT/CN2023/134534 and Chinese Patent Application No. 202211584238.4 are each incorporated herein by reference in their entirety.

### FIELD OF THE TECHNOLOGY

This application relates to the field of computer technologies, and in particular, to a data processing method and apparatus, a device, and a storage medium.

### BACKGROUND OF THE DISCLOSURE

With the continuous development of science and technologies, an increasing number of devices can perform artificial intelligence (AI) data processing. The AI data processing includes a large number of operations on floating-point numbers. The operations on floating-point numbers include an addition operation, a multiplication operation, a multiply-add operation, and the like.

In some data processing methods, when an operation relationship corresponding to an arithmetic operation performed in a current operation order is a multiply-add operation relationship, a multiplication result of two floating-point numbers is calculated first, and then an addition result of the multiplication result and a third floating-point number is calculated to obtain a multiply-add result, so that an operation result in the current operation order can be obtained.

For example, if three floating-point numbers are A, B, and C respectively, and the multiply-add operation relationship is A+B*C, B*C is calculated first to obtain a multiplication result, that is, D. Then A+D is calculated to obtain an operation result of A+B*C.

### SUMMARY

Embodiments of this application provide a data processing method and apparatus, a computer device, and a storage medium, to resolve the problem of low data processing efficiency caused by a long calculation delay in a data processing process.

An embodiment of this application provides a data processing method. The method is performed by a processing circuit in a computer device and includes:
obtaining an arithmetic operation instruction for indicating to perform an arithmetic operation based on a plurality of floating-point numbers;
reading a first floating-point number, a second floating-point number, and a third floating-point number referred to by the plurality of floating-point numbers in response to the arithmetic operation instruction being a multiply-add operation instruction;
performing a multiplication operation on the first floating-point number and the second floating-point number to obtain a multiplication result;
determining a first exponent difference between an exponent of the multiplication result and an exponent of the third floating-point number;
performing alignment shift on at least one of the third floating-point number or the multiplication result according to an alignment shift amount corresponding to the first exponent difference in response to the first exponent difference being less than or equal to a first shift amount threshold, to obtain a first aligned floating-point number and a first alignment multiplication result;
calculating a first addition result between the first aligned floating-point number and the first alignment multiplication result by using a first adder in the processing circuit, and predicting a normalization shift amount required for the first addition result by using a prediction encoder in the processing circuit; and
performing normalization shift on the first addition result according to the normalization shift amount required for the first addition result to obtain a first normalized result, and obtaining an operation result of the multiply-add operation according to the first normalized result.

An embodiment of this application further provides a data processing apparatus, including:
an obtaining module, configured to obtain an arithmetic operation instruction for indicating to perform an arithmetic operation based on a plurality of floating-point numbers;
a reading module, configured to read a first floating-point number, a second floating-point number, and a third floating-point number referred to by the plurality of floating-point numbers in response to the arithmetic operation instruction being a multiply-add operation instruction;
a multiplication module, configured to perform a multiplication operation on the first floating-point number and the second floating-point number to obtain a multiplication result;
an exponent difference determining module, configured to determine a first exponent difference between an exponent of the multiplication result and an exponent of the third floating-point number;
an alignment shift module, configured to perform alignment shift on at least one of the third floating-point number or the multiplication result according to an alignment shift amount corresponding to the first exponent difference in response to the first exponent difference being less than or equal to a first shift amount threshold, to obtain a first aligned floating-point number and a first alignment multiplication result;
an addition module, configured to: calculate a first addition result between the first aligned floating-point number and the first alignment multiplication result by using a first adder in the processing circuit, and predict a normalization shift amount required for the first addition result by using a prediction encoder in the processing circuit; and
a normalization module, configured to perform normalization shift on the first addition result according to the normalization shift amount required for the first addition result to obtain a first normalized result, and obtain an operation result of the multiply-add operation according to the first normalized result.

An embodiment of this application provides a computer-readable readable medium, including a computer program, the computer program, when executed by a processor, implementing the foregoing data processing method.

An embodiment of this application further provides a computer device, including
a memory, configured to store a program instruction; and
a processor, configured to invoke the program instruction stored in the memory, to perform the foregoing data processing method according to the obtained program instruction.

An embodiment of the present invention further provides a computer-readable storage medium, having a computer executable instruction stored therein, the computer executable instruction being configured to cause a computer to perform the foregoing data processing method.

### BRIEF DESCRIPTION OF THE DRAWINGS

FIG. 1A is a schematic principle diagram of a data processing method according to an embodiment of this application.

FIG. 1B is another schematic principle diagram of a data processing method according to an embodiment of this application.

FIG. 1C is another schematic principle diagram of a data processing method according to an embodiment of this application.

FIG. 1D is another schematic principle diagram of a data processing method according to an embodiment of this application.

FIG. 1E is an application scenario of a data processing method according to an embodiment of this application;

FIG. 2 is a schematic flowchart of a data processing method according to an embodiment of this application;

FIG. 3 is a schematic principle diagram of a data processing method according to an embodiment of this application.

FIG. 4A is another schematic principle diagram of a data processing method according to an embodiment of this application.

FIG. 4B is another schematic principle diagram of a data processing method according to an embodiment of this application.

FIG. 4C is another schematic principle diagram of a data processing method according to an embodiment of this application.

FIG. 5A is another schematic principle diagram of a data processing method according to an embodiment of this application.

FIG. 5B is another schematic principle diagram of a data processing method according to an embodiment of this application.

FIG. 6 is another schematic principle diagram of a data processing method according to an embodiment of this application.

FIG. 7A is another schematic principle diagram of a data processing method according to an embodiment of this application.

FIG. 7B is another schematic principle diagram of a data processing method according to an embodiment of this application.

FIG. 7C is another schematic principle diagram of a data processing method according to an embodiment of this application.

FIG. 8 is a schematic structural diagram of a data processing apparatus according to an embodiment of this application.

FIG. 9 is another schematic structural diagram of a data processing apparatus according to an embodiment of this application.

### DESCRIPTION OF EMBODIMENTS

To make the objectives, technical solutions, and advantages of the embodiments of this application more comprehensible, the following clearly and completely describes the technical solutions in the embodiments of this application with reference to the accompanying drawings in the embodiments of this application.

Some terms in the embodiments of this application are explained below to facilitate understanding by a person skilled in the art.

### (1) Multiplexer:

The multiplexer is a circuit that can select any one way according to requirements in a multi-way data transmission process, and is also referred to as a data selector or a multi-way switch.

### (2) Full Adder and Carry Save Adder (CSA):

The full adder is configured to implement a combination circuit in which two binary numbers are added to obtain a sum.

The carry save adder is an adder configured to sum a large number of operands. For example, three source operands are inputted, and two operation results are outputted. The two operation results include a sum and a carry.

The embodiments of this application relate to the field of artificial intelligence (AI) and the field of cloud computing, and may be applied to fields such as intelligent transportation, intelligent farming, intelligent medicine, or maps.

AI involves a theory, a method, a technology, and an application system that use a digital computer or a machine controlled by the digital computer to simulate, extend, and expand human intelligence, perceive an environment, obtain knowledge, and use knowledge to obtain an optimal result. In other words, AI is a comprehensive technology of computer science. It studies the design principles and implementation methods of various machines in an attempt to understand the essence of intelligence and produce a new intelligent machine that can react in a manner similar to human intelligence, so that machines have perception, reasoning, and decision-making functions.

AI is a comprehensive discipline, and relates to a wide range of fields including both hardware-stage technologies and software-stage technologies. The basic AI technologies generally include technologies such as a sensor, a dedicated AI chip, cloud computing, distributed storage, a big data processing technology, an operating/interaction system, and electromechanical integration. AI software technologies mainly include several major directions such as a computer vision technology, a speech processing technology, a natural language processing technology, machine learning/deep learning, autonomous driving, and intelligent transportation. With the development and progress of AI, AI is studied and applied to multiple fields, for example, common fields of smart home, smart customer services, virtual assistants, smart speakers, smart marketing, smart wearable devices, unmanned driving, autonomous driving, drones, robots, smart medicine, vehicle-to-everything, autonomous driving, and intelligent transportation. It is believed that with the further development of future technologies, AI will be applied to more fields, and exert increasingly important values. The solutions provided in the embodiments of this application relate to technologies such as deep learning and augmented reality of AI. Specifically, the solutions are further described by using the following embodiments.

Cloud computing refers to a delivery and use mode of IT infrastructure, and refers to obtaining required resources through a network in an on-demand and easily scalable manner. Cloud computing in a broad sense refers to a delivery and use mode of services, and refers to obtaining required services through a network in an on-demand and easily scalable manner. Such services may be related to IT, software, and the Internet, or may be other services. Cloud computing is a product of fusion of the development of traditional computers and network technologies such as grid computing, distributed computing, parallel computing, utility computing, network storage technologies, virtualization, and load balance.

Cloud computing has developed rapidly with the development of the Internet, real-time data streams, and diversification of connection devices, and the promotion of the demand for search services, social networks, mobile commerce, and open collaboration. Unlike the previous parallel distributed computing, the generation of cloud computing will conceptually promote revolutionary changes in the entire Internet mode and enterprise management mode.

In the embodiments of this application, relevant data such as a target image is involved. When the embodiments of this application are applied to specific products or technologies, user permission or consent is required, and collection, use, and processing of relevant data need to comply with relevant laws, regulations, and standards of relevant countries and regions.

The application fields of the data processing method provided in the embodiments of this application are briefly described below.

With the continuous development of science and technologies, an increasing number of devices can perform AI data processing. For example, AI data processing is performed on an image to transform an image, to obtain a transformed image. In another example, neural network layer computing is performed on an image feature to obtain a transformed feature, or the like.

The AI data processing includes a large number of operations on floating-point numbers. The operations on floating-point numbers include an addition operation, a multiplication operation, a multiply-add operation, and the like.

In some data processing methods, when an arithmetic operation is a multiply-add operation, a multiplication result of two floating-point numbers is calculated first, and then an addition result of the multiplication result and a third floating-point number is calculated to obtain a multiply-add result, so that an operation result of the multiply-add operation can be obtained.

For example, if the three floating-point numbers are A, B, and C respectively, and the multiply-add operation relationship is A+B*C, then B*C is calculated first, and a multiplication result, that is, D, is obtained. Then A+D is calculated, to obtain an operation result of A+B*C.

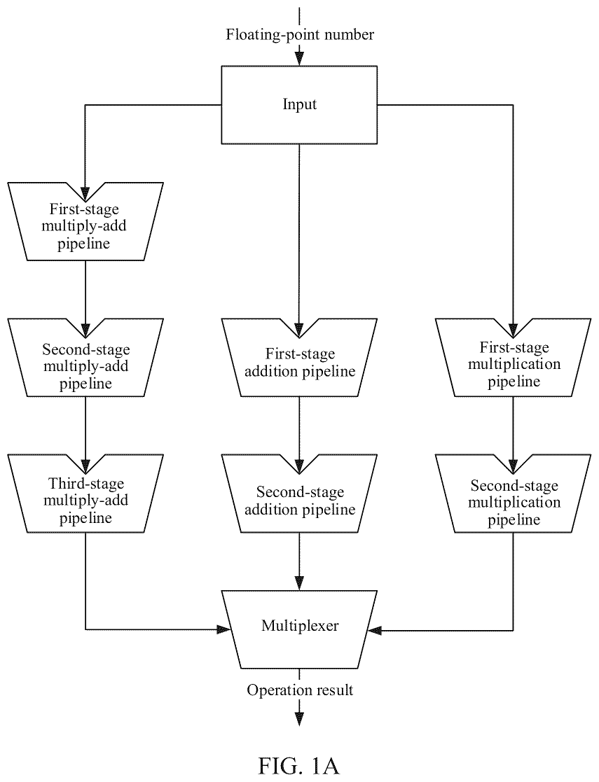

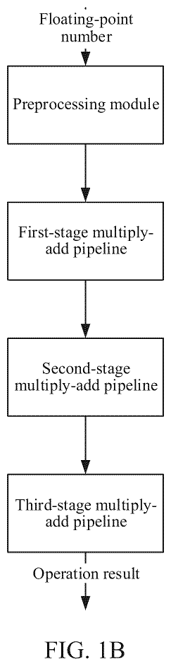

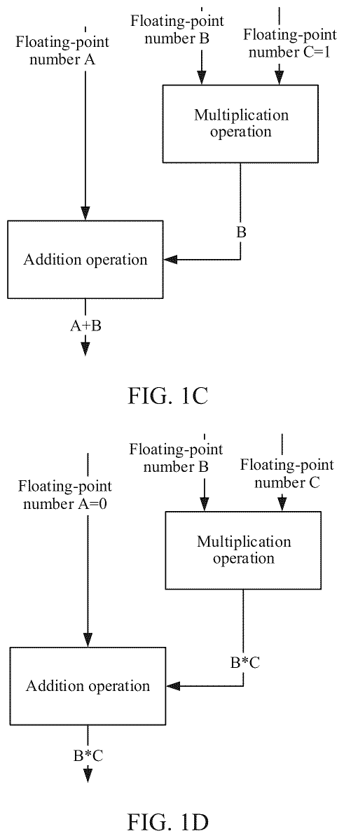

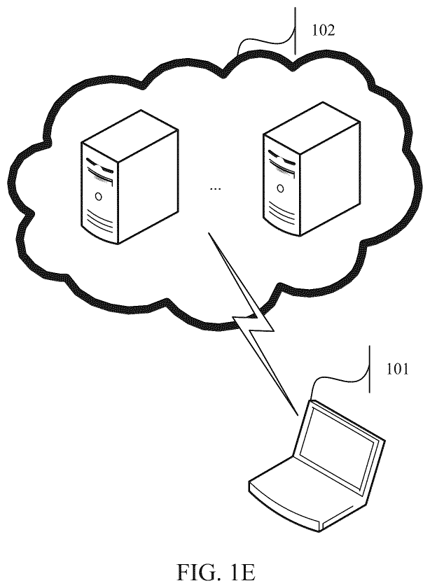

FIG. 1A is a schematic principle diagram of a data processing method. Three computing resources are instantiated in the data processing method. One resource is configured for performing a multiply-add operation based on inputted floating-point numbers, one resource is configured for performing an addition operation based on inputted floating-point numbers, one resource is configured for performing a multiplication operation based on inputted floating-point numbers, and finally, one resource is selected by a multiplexer to output an operation result.

The multiply-add operation may be completed through three stages of pipelines, including a first-stage multiply-add pipeline, a second-stage multiply-add pipeline, and a third-stage multiply-add pipeline. The first-stage multiply-add pipeline may be configured to perform a multiplication operation on two floating-point numbers, the second-stage multiply-add pipeline may be configured to perform alignment shift on a multiplication result of the multiplication operation and a third floating-point number, and the third-stage multiply-add pipeline may be configured to perform an addition operation on the shifted multiplication result and third floating-point number, so that an operation result of the multiply-add operation may be obtained.

The addition operation may be completed through two stages of pipelines, including a first-stage addition pipeline and a second-stage addition pipeline. The first-stage addition pipeline may be configured to perform alignment shift on two floating-point numbers, and the second-stage addition pipeline may be configured to perform an addition operation on the shifted two floating-point numbers, so that an operation result of the addition operation may be obtained.

The multiplication operation may be completed through two stages of pipelines, including a first-stage multiplication pipeline and a second-stage multiplication pipeline. The first-stage multiplication pipeline may be configured to perform a multiplication operation on two floating-point numbers, and the second-stage multiplication pipeline may be configured to round an obtained multiplication result, so that an operation result of the multiplication operation may be obtained.

FIG. 1B is another schematic principle diagram of a data processing method. Only one computing resource is instantiated in the data processing method. The computing resource may be configured for performing a multiply-add operation, or an addition operation, or a multiplication operation. The computing resource is completed through a preprocessing module and three stages of pipelines. The three stages of pipelines include a first-stage multiply-add pipeline, a second-stage multiply-add pipeline, and a third-stage multiply-add pipeline. The first-stage multiply-add pipeline may be configured to perform a multiplication operation on two floating-point numbers, the second-stage multiply-add pipeline may be configured to perform alignment shift on a multiplication result of the multiplication operation and a third floating-point number, and the third-stage multiply-add pipeline may be configured to perform an addition operation on the shifted multiplication result and third floating-point number, so that an operation result of the multiply-add operation may be obtained.

The preprocessing module is configured to select to perform a multiply-add operation, an addition operation, or a multiplication operation. Using three floating-point numbers A, B, and C as an example, referring to FIG. 1C, when the preprocessing module selects a separate addition operation to calculate A+B, because the computing resource first performs a multiplication operation on the floating-point number B and the floating-point number C, the preprocessing module may set the floating-point number C to 1, so that a multiplication result of the multiplication operation is still the floating-point number B. Then, an addition operation is performed on the multiplication result and the floating-point number A, to obtain an operation result of A+B.

Referring to FIG. 1D, when the preprocessing module selects a separate multiplication operation to calculate B*C, the computing resource first performs a multiplication operation on the floating-point number B and the floating-point number C to obtain a multiplication result. Because an addition operation needs to be further performed on the multiplication result and the floating-point number A, the preprocessing module may set the floating-point number A to 0, so that an operation result of B*C is obtained after the addition operation is performed.

However, operations between floating-point numbers usually include a large number of shift processes. For example, for an addition operation, alignment shift needs to be performed on the floating-point numbers first, and then the addition operation is performed. The shift process is to first determine a corresponding shift amount before shift, and then perform corresponding shift according to the determined shift amount. Due to the large shiftable range, the entire shift amount range includes a large shift amount. Therefore, a long calculation delay is generated when one shift amount is determined from the large shift amount, causing a long calculation delay for data processing.

The long calculation delay in the data processing process causes low data processing efficiency.

To resolve the problem of low data processing efficiency caused by the long calculation delay in the data processing process, this application provides a data processing method, performed by a processing circuit in a computer device. In the method, after an arithmetic operation execution for indicating to perform an arithmetic operation based on a plurality of floating-point numbers is received, data processing is performed on the floating-point numbers based on the arithmetic operation instruction, to obtain an operation result of the arithmetic operation.

The arithmetic operation is as follows:
reading a first floating-point number, a second floating-point number, and a third floating-point number referred to by the plurality of floating-point numbers in response to the arithmetic operation instruction being a multiply-add operation instruction. performing a multiplication operation on the first floating-point number and the second floating-point number to obtain a multiplication result, and determining a first exponent difference between an exponent of the multiplication result and an exponent of the third floating-point number; performing alignment shift on at least one of the third floating-point number or the multiplication result according to an alignment shift amount corresponding to the first exponent difference in response to the first exponent difference being less than or equal to a first shift amount threshold, to obtain a first aligned floating-point number and a first alignment multiplication result; calculating a first addition result between the first aligned floating-point number and the first alignment multiplication result by using a first adder in the processing circuit, and predicting a normalization shift amount required for the first addition result by using a prediction encoder in the processing circuit; and performing normalization shift on the first addition result according to the normalization shift amount required for the first addition result to obtain a first normalized result, and obtaining an operation result of the multiply-add operation according to the first normalized result.

In the embodiments of this application, if the multiply-add operation is performed on the floating-point numbers in the data processing process, after the multiplication operation is performed on the first floating-point number and the second floating-point number to obtain the multiplication result, the first exponent difference between the exponent of the multiplication result and the exponent of the third floating-point number is first determined, so that the alignment shift amount during the addition operation can be determined based on the obtained first exponent difference, and there is no need to select a shift amount in an entire range including all shift amount intervals for the addition operation, which can greatly reduce a calculation delay of selecting a shift amount for the addition operation. In addition, the normalization shift amount required for the addition result can be predicted synchronously when the addition result is calculated, so that after the addition result is calculated, normalization shift can be directly performed based on the normalization shift amount required for the addition result, thereby further reducing the calculation delay and improving data processing efficiency.

An application scenario of the data processing method provided in the embodiments of this application is described below.

FIG. 1E is a schematic diagram of an application scenario of a data processing method according to this application. The application scenario includes a client 101 and a server 102. The client 101 may communicate with the server 102. The communication protocol may be communication by using a wired communication technology, for example, communication by connecting to a network cable or a serial cable; or may be communication by using a wireless communication technology, for example, communication by using a technology such as Bluetooth or wireless fidelity (WIFI). This is not specifically limited.

The client 101 generally refers to a device capable of, for example, providing to-be-operated floating-point numbers (for example, a plurality of floating-point numbers for representing a target image) or presenting an operation result (for example, an image conversion result obtained by performing operations on the plurality of floating-point numbers for representing the target image) to the server 102, for example, a terminal device, a third-party application program accessible to the terminal device, or a web page accessible to the terminal device. The terminal device includes but is not limited to a mobile phone, a computer, a smart medical device, a smart home appliance, an in-vehicle terminal, an aircraft, or the like. The server 102 generally refers to a device capable of performing data processing, for example, a terminal device or a server. The server includes but is not limited to a cloud server, a local server, an associated third-party server, or the like. Both the client 101 and the server 102 may adopt cloud computing to reduce occupation of local computing resources; or may adopt cloud storage to reduce occupation of local storage resources.

In some embodiments, the client 101 and the server 102 may be the same device. This is not specifically limited. In the embodiments of this application, an example in which the client 101 and the server 102 are different devices is used for description.

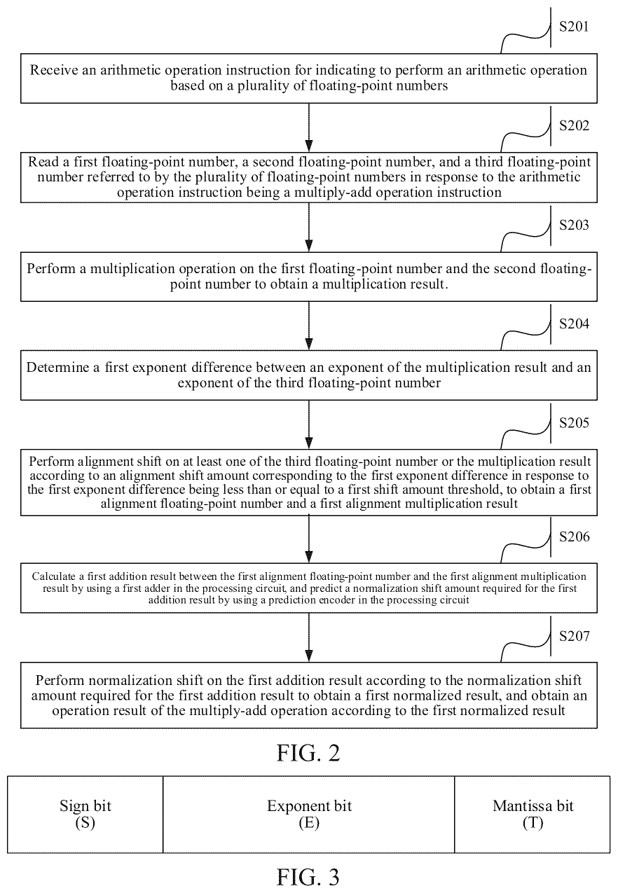

The following describes the data processing method according to the embodiments of this application in detail based on FIG. 1E by using the server 102 as the server and the server as the main body. FIG. 2 is a schematic flowchart of a data processing method according to an embodiment of this application.

S201: Receive an arithmetic operation instruction for indicating to perform an arithmetic operation based on a plurality of floating-point numbers.

In this embodiment of the present invention, the received computing arithmetic operation instruction may be sent by another device such as the client, or may be automatically generated based on computing logic. This is not specifically limited.

In the embodiments of the present invention, the arithmetic operation instruction for indicating to perform an arithmetic operation based on a plurality of floating-point numbers may be a data processing instruction for the target image. The data processing instruction for the target image is a data processing instruction related to the target image. For example, the data processing instruction may be an instruction for performing image preprocessing on the target image, an instruction for performing image post-processing on the image, or an instruction for performing data processing by using a neural network layer in the process of processing the target image. This is not specifically limited.

The target image may be recorded in a form of a plurality of floating-point numbers, and the plurality of floating-point numbers are data related to the target image. For example, the plurality of floating-point numbers represent the target image. In another example, a matrix composed of the plurality of floating-point numbers represents an image feature of the target image. In another example, the plurality of floating-point numbers represent intermediate data or the like of the target image during AI data processing. This is not specifically limited.

In the data processing process, the floating-point numbers may be recorded according to a uniform standard, so that each floating-point number has a uniform data format. For example, each floating-point number follows the IEEE 754 standard. FIG. 3 is a schematic diagram of the IEEE 754 standard.

A floating-point number may be represented by three parts, including a sign bit(S), an exponent bit (E), and a mantissa bit (T). The sign bit may include a one-bit value, for representing whether the floating-point number is positive or negative. The exponent bit may include w bit values, that is, E_0, E_1, . . . , and E_(w−1), for representing the exponent of the floating-point number. The mantissa bit may include p bit values, that is, T_0, T_1, . . . , T_(p−1), for representing the value of the floating-point number.

The arithmetic operation instruction is configured for indicating to perform an arithmetic operation on the plurality of floating-point numbers (that is, perform an arithmetic operation based on the plurality of floating-point numbers). The arithmetic operation includes a plurality of operations such as addition, subtraction, multiplication, division, and multiply-add. This is not specifically limited. When the arithmetic operation instruction indicates a plurality of arithmetic operations, the arithmetic operation instruction is further configured for indicating an operation order of the plurality of arithmetic operations. The operation order represents an order from left to right according to a formula, or an order in which multiplication is calculated first and then addition is calculated. This is not specifically limited.

For example, in the formula A+B*C+D, the arithmetic operation includes a multiply-add operation and an addition operation. The operation order is calculating A+B*C first, and then adding the obtained result to D.

After the arithmetic operation instruction is obtained, data processing may be performed on the floating-point numbers based on the arithmetic operation instruction, to obtain an operation result. The data processing process may include a plurality of arithmetic operations performed according to the operation order. For example, in the foregoing formula A+B*C+D, two arithmetic operations are included. The first operation is calculating A+B*C, and the second operation is adding the result obtained by the first operation to D. Each operation performed according to the operation order corresponds to an operation relationship. For example, in the foregoing formula A+B*C+D, the first arithmetic operation corresponds to a multiply-add operation relationship, and the second arithmetic operation corresponds to an addition operation relationship.

S202: Read a first floating-point number, a second floating-point number, and a third floating-point number referred to by the plurality of floating-point numbers in response to the arithmetic operation instruction being a multiply-add operation instruction.

When it is determined that the arithmetic operation instruction is a multiply-add operation instruction, the arithmetic operation may be represented as the form of A+B*C, B is the first floating-point number, C is the second floating-point number, and A is the third floating-point number.

The arithmetic operation instruction may be further a multiplication operation instruction or an addition operation instruction, which will be described in detail below. During subtraction calculation, subtraction may be converted to addition between two floating-point numbers. Similarly, during division calculation, subtraction may be converted to multiplication between two floating-point numbers. Therefore, a plurality of different operations can be implemented through the multiply-add operation, the multiplication operation, and the addition operation.

S203: Perform a multiplication operation on the first floating-point number and the second floating-point number to obtain a multiplication result.

After the first floating-point number, the second floating-point number, and the third floating-point number are obtained, a multiplication operation may be performed on the first floating-point number and the second floating-point number to obtain a multiplication result, so that an operation result of the arithmetic operation may be obtained based on the multiplication result and the third floating-point number.

In some embodiments, the multiplication operation performed on the first floating-point number and the second floating-point number to obtain the multiplication result may be implemented by using a partial product generation module and a partial product compression module. The partial product generation module may be implemented by using an encoder or the like, and the partial product compression module may be implemented by using a carry save adder (CSA) or the like.

The first floating-point number and the second floating-point number are inputted into an encoder in a processing circuit, and a multiplication operation is performed on values of bits included in a mantissa of the first floating-point number, and a mantissa of the second floating-point number respectively, to obtain corresponding partial products outputted by the encoder. The obtained partial products are inputted to a first CSA in the processing circuit, and the partial products are compressed, to obtain a first carry result and a first original bit result outputted by the first CSA. The obtained first carry result and first original bit result are used as the multiplication result.

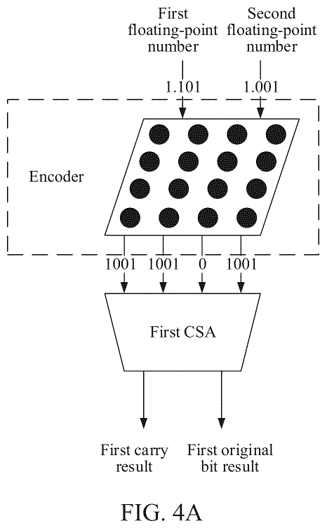

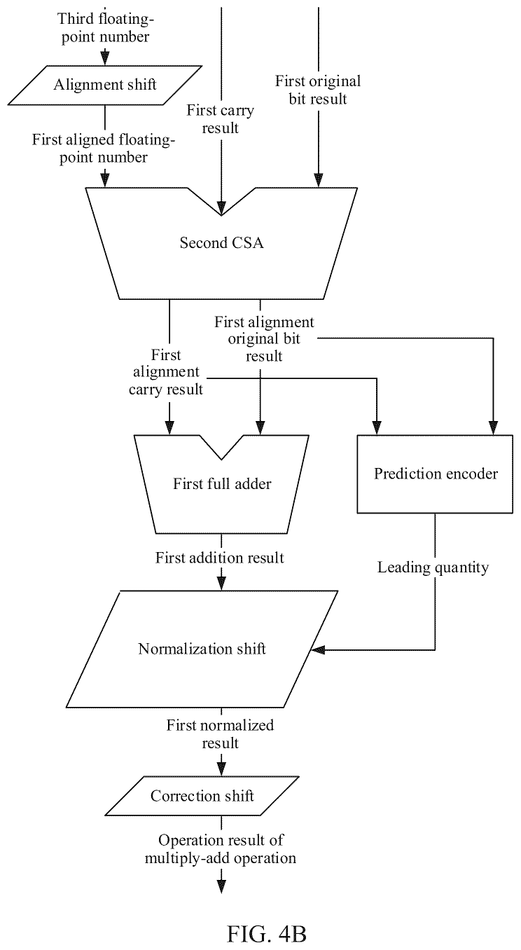

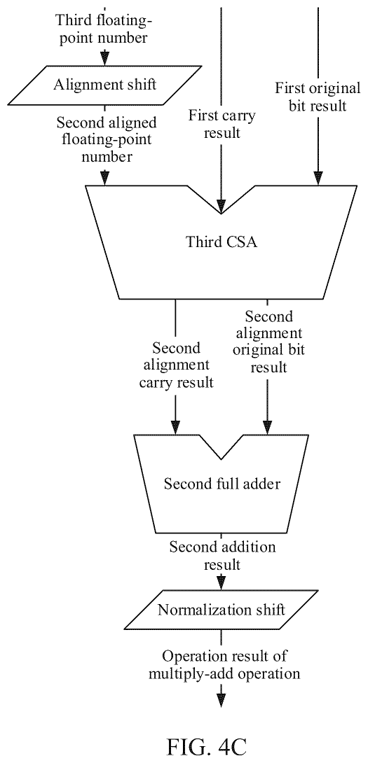

For example, referring to FIG. 4A, the mantissa of the first floating-point number is 1.101, and the mantissa of the second floating-point number is 1.001. The first floating-point number and the second floating-point number are inputted into the encoder. In the encoder, a multiplication operation is performed by using values of bits included in the mantissa of the first floating-point number, that is, “1”, “1”, “0”, and “1”, and the mantissa of the second floating-point number, that is, “1.001”. The obtained partial products include “1001”, “1001”, “0”, and “1001”. The obtained partial products are inputted into the first CSA, and in the first CSA, the partial products are compressed to obtain a first carry result and a first original bit result. The first carry result represents a carry of the multiplication result, and the first original bit result represents an original bit of the multiplication result.

In some embodiments, after the multiplication result is obtained, the multiplication result may be inputted into a first register, a beat operation is performed on the multiplication result in the first register, and subsequent processing may be performed on the beat multiplication result outputted by the first register.

S204: Determine a first exponent difference between an exponent of the multiplication result and an exponent of the third floating-point number.

When the operation result of the arithmetic operation is obtained based on the multiplication result and the third floating-point number, a first exponent difference between an exponent of the multiplication result and an exponent of the third floating-point number may be first determined, and the first exponent difference may represent a difference in exponent between the multiplication result and the third floating-point number.

For binary floating-point numbers, if an exponent difference between two floating-point numbers is small, it indicates a small difference in exponent between the two floating-point numbers, after an addition operation or a subtraction operation is performed on the two floating-point numbers, an operation result including a large number of leading 0s may be obtained. For example, for the operation 111110-111100, the obtained operation result is 000010, which includes 4 leading 0s. In this case, normalization shift needs to be performed on the operation result based on a large shift amount. A large exponent difference between two floating-point numbers indicates a large difference in exponent between the two floating-point numbers. In this case, after an addition operation or a subtraction operation is performed on the two floating-point numbers, an operation result including a large number of leading 0s is not obtained. For example, for the operation 111110-100010, the obtained operation result is 011100, which includes 1 leading 0. In this case, normalization shift is to be performed on the operation result based on a small shift amount.

Normalization shift may be converting one floating-point number according to a specified data format. For example, the floating-point number is converted to be a mantissa part being represented by a pure decimal, and an absolute value of the mantissa being greater than or equal to 1/R (R is a base of a computer carry counting system) and less than or equal to 1. The specified data format is, for example, a data format corresponding to the IEEE 754 standard.

S205: Perform alignment shift on at least one of the third floating-point number or the multiplication result according to an alignment shift amount corresponding to the first exponent difference in response to the first exponent difference being less than or equal to a first shift amount threshold, to obtain a first aligned floating-point number and a first alignment multiplication result.

After the first exponent difference is obtained, when the first exponent difference is less than or equal to the first shift amount threshold, alignment shift may be performed on the multiplication result and the third floating-point number based on an alignment shift amount corresponding to the first exponent difference, to obtain a first aligned floating-point number and a first alignment multiplication result.

The alignment shift amount corresponding to the first exponent difference may be represented as two shift amounts. During the alignment shift, one shift amount is configured for shifting the third floating-point number, and the other shift amount is configured for shifting the multiplication result. The alignment shift amount may also be represented as only one shift amount. During the alignment shift, only the third floating-point number is shifted, so that the third floating-point number and the multiplication result are aligned. Alternatively, only the multiplication result is shifted, so that the third floating-point number and the multiplication result are aligned. This is not specifically limited.

In some embodiments, after the first exponent difference is determined, a corresponding alignment shift amount may be determined according to the first exponent difference. For example, the first exponent difference is used as the corresponding alignment shift amount. Assuming that the first exponent difference is 3, the alignment shift amount corresponding to the first exponent difference is 3, or the like. In another example, the first exponent difference is split into a sum of two numbers, and the two numbers are used as the alignment shift amount corresponding to the first exponent difference. Assuming that the first exponent difference is 3, and 3 may be split into a sum of 1 and 2, 1 and 2 may be used as the alignment shift amount corresponding to the first exponent difference.

Alignment shift is performed on the third floating-point number and the multiplication result based on the alignment shift amount corresponding to the first exponent difference, to obtain a first aligned floating-point number and a first alignment multiplication result. Due to a large shift amount range of the floating-point number, the alignment shift amount can be determined faster based on the first exponent difference, thereby reducing the calculation delay and improving data processing efficiency.

When alignment shift is performed on the third floating-point number and the multiplication result based on the alignment shift amount corresponding to the first exponent difference, to obtain a first aligned floating-point number and a first alignment multiplication result, the multiplication result may be represented by using the first carry result and the first original bit result outputted by the first CSA, and the obtained alignment multiplication result may include the first multiplication carry result and the first multiplication original bit result.

After the first aligned floating-point number and the first alignment multiplication result are obtained, the addition operation may be performed on the first aligned floating-point number and the first alignment multiplication result to obtain a first addition result. The first addition result is an initial addition result, and normalization shift is to be performed on the first addition result subsequently.

The first exponent difference being less than or equal to the first shift amount threshold indicates a small shift amount during alignment shift. According to the foregoing descriptions, during the addition operation, a large quantity of leading 0s may be generated. Therefore, normalization shift with a large shift amount is performed to obtain the addition result. Because the processes of waiting to obtain the addition result and determining the shift amount of the normalization shift are time-consuming, in this case, the calculation delay may be reduced by using the operation process of operation S206:

S206: Calculate a first addition result between the first aligned floating-point number and the first alignment multiplication result by using a first adder in the processing circuit, and predict a normalization shift amount required for the first addition result by using a prediction encoder in the processing circuit.

In some embodiments, the first adder includes a second CSA and a first full adder. A specific operation process of S206 is as follows:

The first aligned floating-point number and the first alignment multiplication result are inputted into the second CSA, and the first aligned floating-point number and the first alignment multiplication result are compressed in the second CSA, to obtain a first alignment carry result and a first alignment original bit result outputted by the second CSA. The first alignment multiplication result may be represented by using the foregoing first multiplication carry result and first multiplication original bit result. This is not specifically limited.

After the first alignment carry result and the first alignment original bit result are obtained, the obtained first alignment carry result and first alignment original bit result may be inputted into the first full adder and the prediction encoder respectively. The first addition result is obtained by using the first full adder, and the quantity of specified values included before the specified bits in an exponent of the first addition result is predicted by using the prediction encoder, to obtain a leading quantity (that is, a normalization shift amount required for the first addition result) outputted by the prediction encoder. The quantity of the specified values included before the specified bits may be the foregoing quantity of leading 0s.

In consideration of the time-consuming process of the addition operation, if after the first addition result is calculated, the normalization shift amount required for the first addition result is determined, and then normalization shift is performed, a long calculation delay is caused. Therefore, in the embodiments of this application, after the first alignment carry result and the first alignment original bit result are obtained, when the addition operation is performed by using the first full adder to obtain the first addition result, the normalization shift amount required for the first addition result is predicted synchronously by using the prediction encoder. Therefore, when the first full adder calculates the first addition result, normalization shift may be performed on the first addition result directly based on the predicted normalization shift amount required for the first addition result, thereby reducing the calculation delay and improving the data processing efficiency.

In some embodiments, the first alignment carry result and the first alignment original bit result are inputted into the first full adder to obtain the first addition result outputted by the first adder. Subsequent processing may be performed after the first addition result is inputted into a second register for a beat operation. This is not specifically limited.

S207: Perform normalization shift on the first addition result according to the normalization shift amount required for the first addition result to obtain a first normalized result, and obtain an operation result of the multiply-add operation according to the first normalized result.

Because the prediction of the normalization shift amount required for the first addition result and the process of determining the first addition result are synchronized, there is no need to take time to determine the shift amount required for performing normalization shift on the first addition result after the first addition result is determined. Instead, normalization shift is performed on the first addition result directly based on the predicted normalization shift amount required for first addition result, to obtain the first normalized result, which can greatly reduce the calculation delay.

In some embodiments, because the process of predicting the normalization shift amount required for the first addition result may be inaccurate, after the first normalized result is obtained, the first normalized result may be verified, to determine whether the first normalized result meets a preset floating-point number standard. The preset floating-point number standard is, for example, the foregoing IEEE 754 standard. This is not specifically limited.

The obtained first normalized result determined to meet the preset floating-point number standard means that the predicted normalization shift amount is accurate, and the obtained first normalized result is accurate. Therefore, the first normalized result can be used as the operation result of the multiply-add operation. The first normalized result determined to not meet the floating-point number standard indicates that there is an error in the predicted normalization shift amount, but the error is generally small relative to the shift amount of the normalization shift. Therefore, correction shift is performed on the first normalized result according to the floating-point number standard, and the first normalized result after the correction shift is used as the operation result of the multiply-add operation. During the correction shift, no large time consumption occurs. Therefore, the effect of reducing the calculation delay can also be achieved.

In some embodiments, after the first exponent difference is obtained, when the first exponent difference is greater than or equal to a second shift amount threshold, alignment shift may be performed on the multiplication result and the third floating-point number based on an alignment shift amount corresponding to the first exponent difference, to obtain a second aligned floating-point number and a second alignment multiplication result. The first shift amount threshold is less than or equal to the second shift amount threshold.

After the second aligned floating-point number and the second alignment multiplication result are obtained, the addition operation may be performed on the second aligned floating-point number and the second alignment multiplication result to obtain a second addition result. The second addition result is an initial addition result, and normalization shift may still be performed on the second addition result subsequently.

If the first exponent difference is greater than or equal to the second shift amount threshold, it indicates a large shift amount during alignment shift. Because the shift amount during alignment shift is determined according to the first exponent difference, rather than being determined from the entire shift amount range, even if the shift amount during alignment shift is large, the effect of reducing the calculation delay can be achieved. In addition, according to the foregoing description, during the addition operation, because of the large shift amount during alignment shift, a large number of leading 0s is not generated, and only normalization shift with a small shift amount is to be performed to obtain the addition result. Therefore, in this case, the second addition result between the second aligned floating-point number and the second alignment multiplication result may be calculated by using the second adder in the processing circuit.

In some embodiments, the second adder includes a third CSA and a second full adder, and an addition operation process of the second aligned floating-point number and the second alignment multiplication result is specifically as follows.

The second aligned floating-point number and the second alignment multiplication result are inputted into the third CSA, and the second aligned floating-point number and the second alignment multiplication result are compressed in the third CSA, to obtain a second alignment carry result and a second alignment original bit result outputted by the third CSA. The second alignment multiplication result may also be represented by using the foregoing first multiplication carry result and first multiplication original bit result. This is not specifically limited. Subsequent processing may be performed after the second alignment carry result and the second alignment original bit result are inputted into a third register for a beat operation. This is not specifically limited.

After the second alignment carry result and the second alignment original bit result are obtained, the obtained second alignment carry result and second alignment original bit result are inputted into the second full adder to obtain the second addition result outputted by the second full adder.

After the second addition result is calculated, because of a small shift amount during normalization shift in this case, normalization shift may be performed on the second addition result directly according to the preset floating-point number standard to obtain a second normalization shift result, and then the operation result of the multiply-add operation is obtained according to the second normalization shift result.

In some embodiments, after a normalized result (for example, a first normalized result or a second normalized result) is obtained, the normalized result may be inputted into a rounding operator, and a mantissa of the normalized result is rounded in the rounding operator, to obtain an operation result of the multiply-add operation outputted by the rounding operator. In some data operation methods, the multiply-add operation, is different from a method in which a multiplication operation and an addition operation are cascaded. In the method in which a multiplication operation and an addition operation are cascaded, after a multiplication result is obtained, the multiplication result needs to be rounded, and after a multiply-add result is obtained, the multiply-add result also needs to be rounded. Because rounding is performed twice, the precision of the obtained operation result is greatly reduced. However, in the embodiments of this application, during the multiply-add operation, rounding is performed only once after the multiply-add result is obtained, which ensures the precision of the operation result to some extent.

The multiplication result obtained based on FIG. 4A includes the first carry result and the first original bit result, so that after the first exponent difference between the third floating-point number and the multiplication result is determined, if the first exponent difference is less than or equal to the first shift amount threshold, refer to FIG. 4B for a process of subsequently obtaining the operation result of the multiply-add operation.

Alignment shift is performed on the third floating-point number according to an alignment shift amount corresponding to the first exponent difference, to obtain a first aligned floating-point number. The first aligned floating-point number, the first carry result, and the first original bit result are inputted into a second CSA, and compressed in the second CSA to obtain a first alignment carry result and a first alignment original bit result.

The first alignment carry result and the first alignment original bit result are inputted into the first full adder and the prediction encoder respectively. The first addition result is obtained by using the first full adder, and the quantity of specified values included before the specified bits in an exponent of the first addition result is predicted by using the prediction encoder, to obtain a leading quantity (that is, a normalization shift amount required for the first addition result) outputted by the prediction encoder.

Normalization shift is performed on the first addition result based on the normalization shift amount required for the first addition result, to obtain a first normalized result. When the obtained first normalized result is determined to meet the preset floating-point number standard, the first normalized result is used as the operation result of the multiply-add operation. When the first normalized result is determined to not meet the floating-point number standard, correction shift is performed on the first normalized result according to the floating-point number standard, to obtain the operation result of the multiply-add operation.

The multiplication result obtained based on FIG. 4A includes the first carry result and the first original bit result. After the first exponent difference between the third floating-point number and the multiplication result is determined, if the first exponent difference is greater than or equal to the second shift amount threshold, a process of subsequently obtaining the operation result of the multiply-add operation is performed, as described with reference to FIG. 4C.

Alignment shift is performed on the third floating-point number according to the alignment shift amount corresponding to the first exponent difference, to obtain a second aligned floating-point number. The second aligned floating-point number, the first carry result, and the first original bit result are inputted into a third CSA, and compressed in the third CSA, to obtain a second alignment carry result and a second alignment original bit result.

The second alignment carry result and the second alignment original bit result are inputted into a second full adder, to obtain a second addition result outputted by the second full adder. Normalization shift is performed on the second addition result based on the floating-point number standard, to obtain an operation result of the multiply-add operation.

In some embodiments, when it is determined that the arithmetic operation instruction is an addition operation instruction, a fourth floating-point number and a fifth floating-point number referred to by the plurality of floating-point numbers are read. For the addition operation, the arithmetic operation may be represented in a form of A+B. In this case, A is the fourth floating-point number, and B is the fifth floating-point number.

After the fourth floating-point number and the fifth floating-point number are obtained, a second exponent difference between an exponent of the fourth floating-point number and an exponent of the fifth floating-point number may be determined, and the second exponent difference may represent a difference in exponent between the fourth floating-point number and the fifth floating-point number. After the second exponent difference is obtained, when the second exponent difference is less than or equal to the first shift amount threshold, alignment shift may be performed on at least one of the fourth floating-point number or the fifth floating-point number based on an alignment shift amount corresponding to the second exponent difference to obtain a third aligned floating-point number and a fourth aligned floating-point number, and an addition operation is performed on the third aligned floating-point number and the fourth aligned floating-point number to obtain an operation result of the addition operation. For the process of performing the addition operation on the third aligned floating-point number and the fourth aligned floating-point number, the third aligned floating-point number and the fourth aligned floating-point number may be used as the foregoing first aligned floating-point number and first alignment multiplication result respectively, and reference may be made to the foregoing process of performing the addition operation on the first aligned floating-point number and the first alignment multiplication result, or the same apparatus such as the CSA, the full adder, or the prediction encoder used in the foregoing process of performing the addition operation on the first aligned floating-point number and the first alignment multiplication result may be used, to implement reuse of computing resources, and avoid the need of instantiating a large quantity of computing resources, thereby reducing the occupation area of the computing resources, and improving the surface effect ratio.

To ensure that the addition operation and the multiply-add operation can reuse the second CSA and the third CSA, a multiplexer may be added before the second CSA and the third CSA. During the multiply-add operation, the multiplexer selects to input the multiplication result into the second CSA or the third CSA; and during the addition operation, the multiplexer selects to input the fourth floating-point number or the fifth floating-point number into the second CSA or the third CSA. When the multiplexer selects to input the fourth floating-point number into the second CSA or the third CSA, the fifth floating-point number is used as the foregoing third floating-point number and is inputted into the second CSA or the third CSA. When the multiplexer selects to input the fifth floating-point number into the second CSA or the third CSA, the fourth floating-point number is used as the foregoing third floating-point number and is inputted into the second CSA or the third CSA.

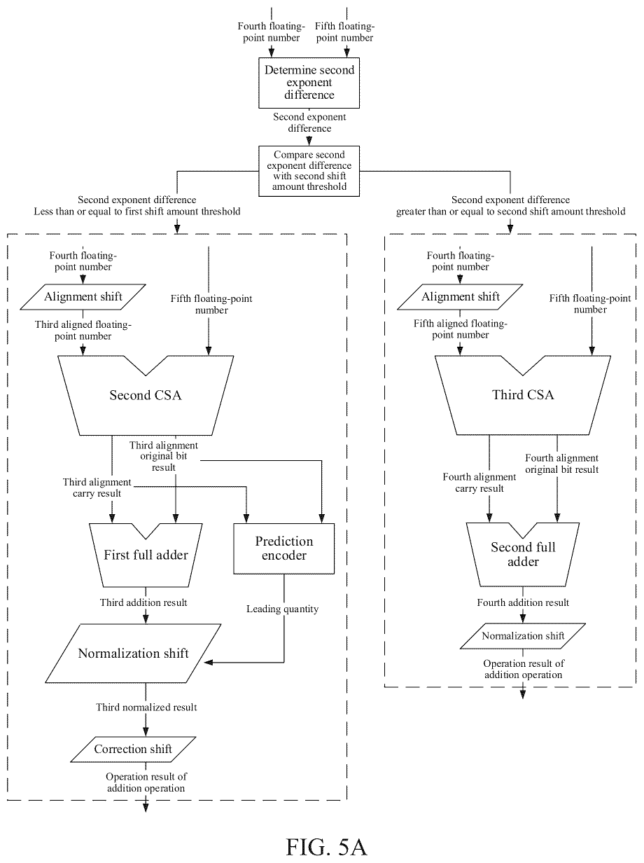

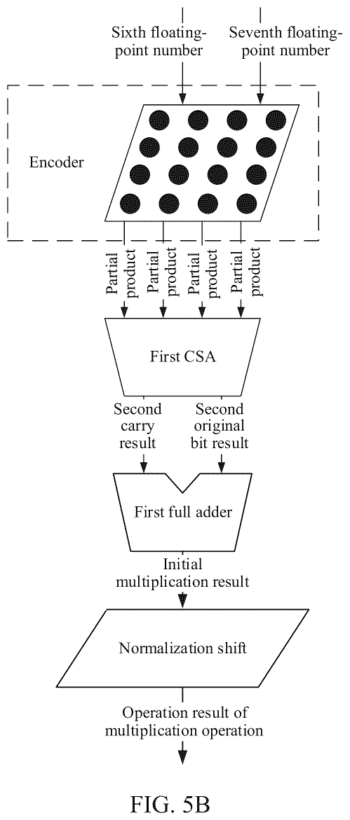

Referring to FIG. 5A, a second exponent difference between the exponent of the fourth floating-point number and the exponent of the fifth floating-point number is determined. If the second exponent difference is less than or equal to the first shift amount threshold, a process of obtaining the operation result of the addition operation is as follows.

Alignment shift is performed on the fourth floating-point number according to an alignment shift amount corresponding to the second exponent difference, to obtain a third aligned floating-point number. The third aligned floating-point number and the fifth floating-point number are inputted into the second CSA, and compressed in the second CSA, to obtain a third alignment carry result and a third alignment original bit result. Further actions to obtain the third alignment carry result and the third alignment original bit result may be performed according to the description of the related content in FIG. 4B. Details are not described herein again.

Referring to FIG. 5A, a second exponent difference between the exponent of the fourth floating-point number and the exponent of the fifth floating-point number is determined. If the second exponent difference is greater than or equal to the second shift amount threshold, a process of obtaining the operation result of the addition operation is as follows.

Alignment shift is performed on the fourth floating-point number according to an alignment shift amount corresponding to the second exponent difference, to obtain a fifth aligned floating-point number. The fifth aligned floating-point number and the fifth floating-point number are inputted into the third CSA, and compressed in the third CSA, to obtain a fourth alignment carry result and a fourth alignment original bit result. Further actions to obtain the fourth alignment carry result and the fourth alignment original bit result may be performed according to the description of the related content in FIG. 4C. Details are not described herein again.

In some embodiments, when it is determined that the arithmetic operation instruction is a multiplication operation instruction, a sixth floating-point number and a seventh floating-point number referred to by the plurality of floating-point numbers are read. For the multiplication operation, the arithmetic operation may be represented in a form of A*B. In this case, A is the sixth floating-point number, and B is the seventh floating-point number.

After the sixth floating-point number and the seventh floating-point number are obtained, the multiplication operation may be performed on the sixth floating-point number and the seventh floating-point number, to obtain an operation result of the arithmetic operation.

In some embodiments, for the process of performing the multiplication operation on the sixth floating-point number and the seventh floating-point number to obtain the operation result of the arithmetic operation, reference may be made to the foregoing process of performing the multiplication operation on the first floating-point number and the second floating-point number, or the same apparatus such as the CSA or the encoder used in the foregoing process of performing the multiplication operation on the first floating-point number and the second floating-point number may be used, to implement reuse of computing resources, and avoid the need of instantiating a large quantity of computing resources, thereby reducing the occupation area of the computing resources, and improving the surface effect ratio.

Referring to FIG. 5B, the sixth floating-point number and the seventh floating-point number are inputted into the encoder as the foregoing first floating-point number and second floating-point number respectively, and a multiplication operation is performed on values of bits included in a mantissa of the sixth floating-point number, and a mantissa of the seventh floating-point number respectively, to obtain corresponding partial products outputted by the encoder. The obtained partial products are inputted into the first CSA, and compressed, to obtain a second carry result and a second original bit result outputted by the first CSA. The obtained second carry result and the second original bit result are inputted into a third full adder, to obtain an initial multiplication result outputted by the third full adder. Normalization shift is performed on the initial multiplication result according to the preset floating-point number standard, to obtain an operation result of the multiplication operation.

The following uses an example in which one computing resource is instantiated. Processes such as the multiply-add operation, the addition operation, and the multiplication operation are described in the following examples. In the embodiments of this application, only one computing resource needs to be instantiated to implement a plurality of operation processes. Comprehensive evaluation is performed through a comprehensive tool design compiler. The data processing method provided in the embodiments of this application has an occupation area of 1725 um\hat{ }2, while the foregoing manner of instantiating three computing resources has an occupation area of 3100 um\hat{ }2. The data processing method provided in the embodiments of this application has a higher surface effect ratio.

In some embodiments, because the reuse of computing resources can implement processes such as the multiply-add operation, the addition operation, and the multiplication operation, a multiplexer may be added before rounding. During the multiply-add operation, the multiplexer selects the multiply-add result for rounding, to obtain the operation result; during the addition operation, the multiplexer selects the addition result for rounding, to obtain the operation result; and during the multiplication operation, the multiplexer selects the multiplication result for rounding, to obtain the operation result. In this way, in the entire operation process, no matter how many operation processes can be implemented, rounding is performed only once, to avoid reducing the precision of the obtained operation result by concatenation of a plurality of rounding processes.

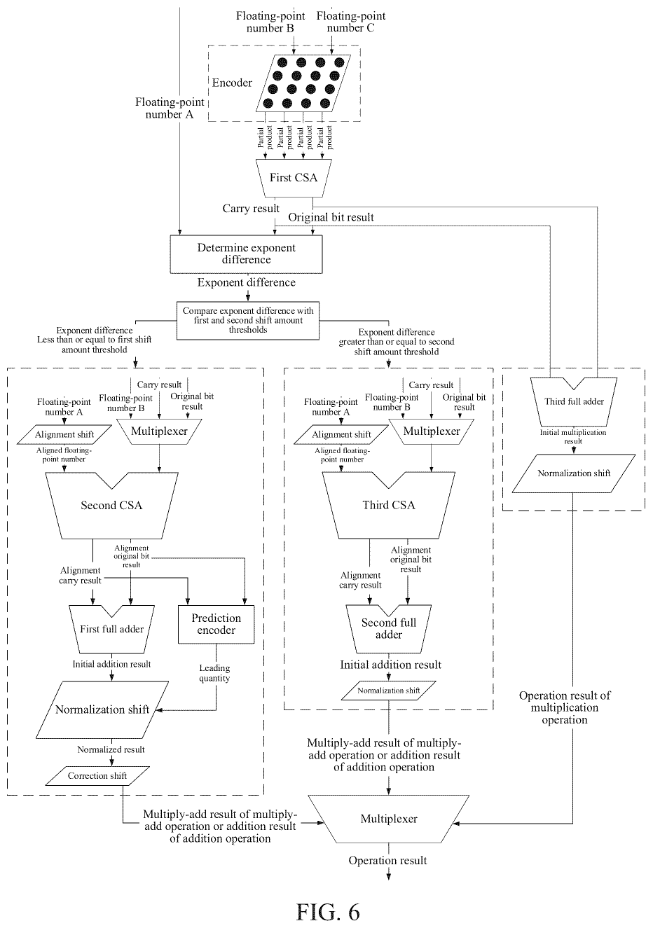

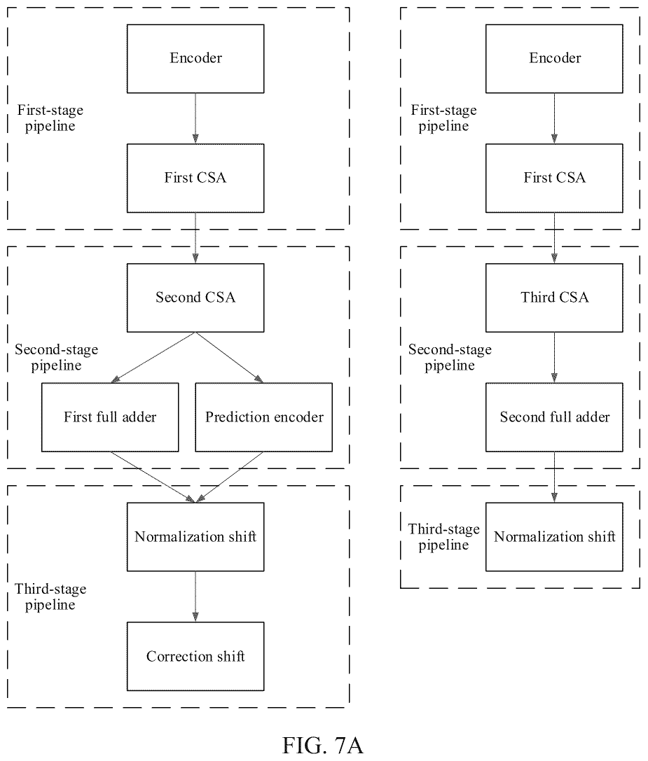

A floating-point number A, a floating-point number B, and a floating-point number C are used as an example. One computing resource instantiated in the embodiments of this application, referring to FIG. 6, includes three stages of pipelines.

A first-stage pipeline includes an encoder and a first CSA. The encoder is configured to perform a multiplication operation on values of bits included in a mantissa of the floating-point number B, and a mantissa of the floating-point number C during the multiply-add operation or the multiplication operation, to obtain partial products. The first CSA is configured to compress the partial products outputted by the encoder during the multiply-add operation or the multiplication operation, to obtain a corresponding carry result and a corresponding original bit result. The carry result may be the foregoing first carry result, second carry result, or the like. The original bit result may be the foregoing first original bit result, second original bit result, or the like.

A second-stage pipeline includes a multiplexer, a second CSA, a first full adder, a prediction encoder, and a third CSA. The multiplexer is configured to select to input the carry result and the original bit result into the second CSA or the third CSA during the multiply-add operation; and select to input the floating-point number B into the second CSA or the third CSA during the addition operation.

The second CSA is configured to: during the multiply-add operation or the addition operation, when an exponent difference between two floating-point numbers participating in the addition operation is less than or equal to the first shift amount threshold, after performing alignment shift on the floating-point number A to obtain an aligned floating-point number, compress the aligned floating-point number, the carry result, and the original bit result, to obtain an alignment carry result and an alignment original bit result.

The first full adder is configured to perform an addition operation on the alignment carry result and the alignment original bit result during the multiply-add operation or the addition operation, to obtain an initial addition result. The prediction encoder is configured to predict a leading quantity of leading 0s in the obtained initial addition result while the first full adder performs the addition operation, during the multiply-add operation or the addition operation. When the prediction encoder is not used for prediction, the initial addition result is the foregoing addition result. Therefore, the foregoing predicted addition result includes the leading quantity of leading 0s, which may be understood as the predicted initial addition result including the leading quantity of leading 0s.

The third CSA is configured to: during the multiply-add operation or the addition operation, when an exponent difference between two floating-point numbers participating in the addition operation is greater than or equal to a second shift amount threshold, after performing alignment shift on the floating-point number A to obtain an aligned floating-point number, compress the aligned floating-point number, the carry result, and the original bit result, to obtain an alignment carry result and an alignment original bit result.

A third-stage pipeline includes a second full adder and a third full adder. In the third-stage pipeline, during the multiply-add operation or the addition operation, when an exponent difference between two floating-point numbers participating in the addition operation is less than or equal to the first shift amount threshold, normalization shift is performed on the initial addition result based on the leading quantity, to obtain a normalized result. Correction shift is performed on the normalized result, to obtain a multiply-add result of the multiply-add operation or an addition result of the addition operation.

During the multiply-add operation or the addition operation, when an exponent difference between two floating-point numbers participating in the addition operation is greater than or equal to the second shift amount threshold, the second full adder is configured to perform the addition operation on the alignment carry result and the alignment original bit result to obtain an initial addition result. Normalization shift is performed on the initial addition result, to obtain a multiply-add result of the multiply-add operation or an addition result of the addition operation.

The third full adder is configured to: during the multiplication operation, perform an addition operation on the carry result and the original bit result obtained in the first-stage pipeline, to obtain an initial multiplication result. Normalization shift is performed on the initial multiplication result, to obtain a multiply-add result of the multiplication operation.

Finally, a multiplexer uses the multiply-add result as a final operation result during the multiply-add operation; uses the addition result as a final operation result during the addition operation and uses the multiplication result as a final operation result during the multiplication operation.

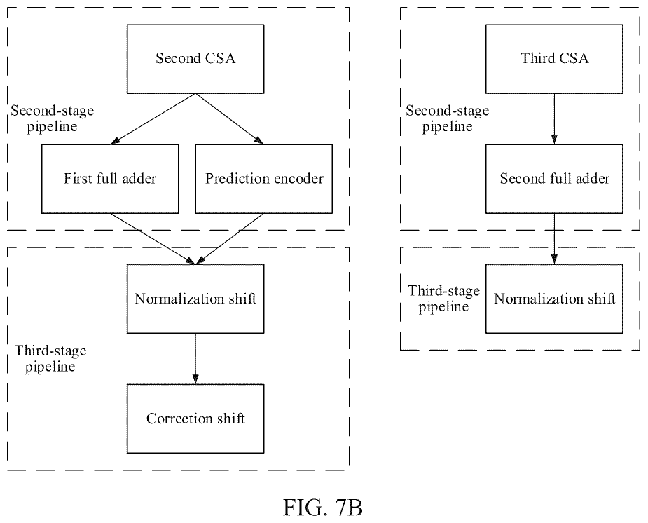

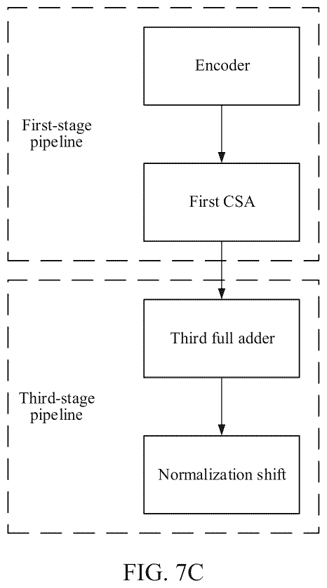

In the embodiments of this application, a plurality of operation processes can be implemented by using only one resource instantiated in FIG. 6. For the multiply-add operation process, referring to FIG. 7A, data processing is performed in the first-stage pipeline by using the encoder and the first CSA; data processing is performed in the second-stage pipeline by using the second CSA, the first full adder, and the prediction encoder, or data processing is performed in the second-stage pipeline by using the third CSA and the second full adder; and normalization shift and correction shift are performed in the third-stage pipeline, or normalization shift is performed in the third-stage pipeline.

For the addition operation process, referring to FIG. 7B, there is no need to perform the first-stage pipeline; data processing is performed in the second-stage pipeline by using the second CSA, the first full adder, and the prediction encoder, or data processing is performed in the second-stage pipeline by using the third CSA and the second full adder; and normalization shift and correction shift are performed in the third-stage pipeline, or normalization shift is performed in the third-stage pipeline.

For the multiplication operation process, referring to FIG. 7C, data processing is performed in the first-stage pipeline by using the encoder and the first CSA. There is no need to perform the second-stage pipeline. Data processing is performed in the third-stage pipeline by using the third full adder, and normalization shift is performed.

In the embodiments of this application, in a separate addition operation and a separate multiplication operation, only two stages of pipelines are required to complete the operations. In some data processing methods, referring to FIG. 1B, three stages of pipelines are required to complete the operations. In addition, in the embodiments of this application, only one computing resource needs to be instantiated to implement a separate addition operation, a separate multiplication operation, and a multiply-add operation, thereby reducing the resource occupation area and improving the surface effect ratio. In some data processing methods, referring to FIG. 1A, three computing resources need to be instantiated, and the surface effect ratio is low.

In the embodiments of this application, only three stages of pipelines are required to complete the multiply-add operation. For the separate addition operation and the addition operation in the multiply-add operation, during the operations, the data processing efficiency is improved by reducing the calculation delay in selecting the shift amount during alignment shift. In a case that the shift amount during the alignment shift is small, a manner of predicting the shift amount during the normalization shift is used, to further reduce the calculation delay in selecting the shift amount during the normalization shift, and further improve the data processing efficiency.

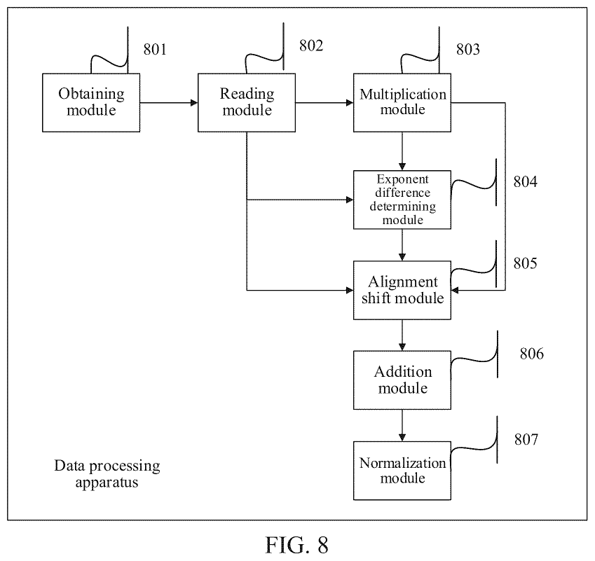

Based on the same inventive concept, an embodiment of this application provides a data processing apparatus, which can implement functions corresponding to the foregoing data processing method. Referring to FIG. 8, the apparatus includes:
an obtaining module 801, configured to obtain an arithmetic operation instruction for indicating to perform an arithmetic operation based on a plurality of floating-point numbers;
a reading module 802, configured to read a first floating-point number, a second floating-point number, and a third floating-point number referred to by the plurality of floating-point numbers in response to the arithmetic operation instruction being a multiply-add operation instruction;
a multiplication module, configured to perform a multiplication operation on the first floating-point number and the second floating-point number to obtain a multiplication result;
an exponent difference determining module, configured to determine a first exponent difference between an exponent of the multiplication result and an exponent of the third floating-point number;
an alignment shift module, configured to perform alignment shift on at least one of the third floating-point number or the multiplication result according to an alignment shift amount corresponding to the first exponent difference in response to the first exponent difference being less than or equal to a first shift amount threshold, to obtain a first aligned floating-point number and a first alignment multiplication result;
an addition module, configured to: calculate a first addition result between the first aligned floating-point number and the first alignment multiplication result by using a first adder in the processing circuit, and predict a normalization shift amount required for the first addition result by using a prediction encoder in the processing circuit; and
a normalization module, configured to perform normalization shift on the first addition result according to the normalization shift amount required for the first addition result to obtain a first normalized result, and obtain an operation result of the multiply-add operation according to the first normalized result.

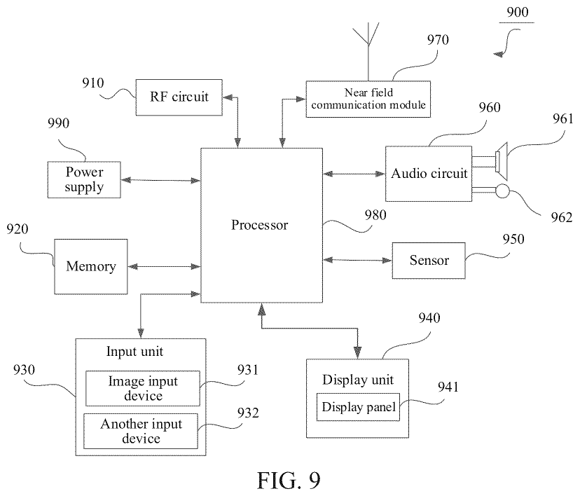

Referring to FIG. 9, the data processing apparatus may run on a computer device 900. A current version and a historical version of a data storage program and application software corresponding to the data storage program may be installed on the computer device 900. The computer device 900 includes a processor 980 and a memory 920. In some embodiments, the computer device 900 may include a display unit 940. The display unit 940 includes a display panel 941, configured to display an interface for an interactive operation by a user, and the like.

In a possible embodiment, the display panel 941 may be configured in a form of a liquid crystal display (LCD), an organic light-emitting diode (OLED), or the like.

The processor 980 is configured to read a computer program and then perform a method defined by the computer program. For example, the processor 980 reads a data storage program, a file, or the like, to run the data storage program on the computer device 900, and display a corresponding interface on the display unit 940. The processor 980 may include one or more general-purpose processors, and may further include one or more digital signal processors (DSPs), configured to perform related operations to implement the technical solutions provided in the embodiments of this application.

The memory 920 generally includes an internal memory and an external memory. The internal memory may be a random access memory (RAM), a read-only memory (ROM), a CACHE, or the like. The external memory may be a hard disk, an optical disc, a USB flash drive, a floppy disk, a tape drive, or the like. The memory 920 is configured to store a computer program and other data. The computer program includes an application program corresponding to each client, and the like. The other data may include data generated after an operating system or the application program is run. The data includes system data (for example, a configuration parameter of the operating system) and user data. In this embodiment of this application, program instructions are stored in the memory 920. The processor 980 executes the program instructions in the memory 920 to implement any one of the foregoing methods.

The display unit 940 is configured to receive inputted digit information, character information, or contact touch operation/non-contact gesture, and generate a signal input related to the user setting and function control of the computer device 900. Specifically, in this embodiment of the present invention, the display unit 940 may include a display panel 941. The display panel 941, for example, a touchscreen, may collect a touch operation of a user on or near the display panel 941 (such as an operation of a user on or near the display panel 941 by using any suitable object or accessory such as a finger or a stylus), and drive a corresponding connection apparatus according to a preset program.

In a possible embodiment, the display panel 941 may include two parts: a touch detection apparatus and a touch controller. The touch detection apparatus detects a touch position of a player, detects a signal generated by the touch operation, and transfers the signal to the touch controller. The touch controller receives the touch information from the touch detection apparatus, converts the touch information into touch point coordinates, and sends the touch point coordinates to the processor 980. Moreover, the touch controller can receive and execute a command sent from the processor 980.

The display panel 941 may be a resistive, capacitive, infrared, or surface sound wave type display panel. In addition to the display unit 940, in some embodiments, the computer device 900 may further include an input unit 930. The input unit 930 may include an image input device 931 and another input device 932. The another input device 932 may include, but is not limited to, one or more of a physical keyboard, a functional key (such as a volume control key or a switch key), a track ball, a mouse, and a joystick.

In addition to the foregoing, the computer device 900 may further include a power supply 990 configured to supply power to other modules, an audio circuit 960, a near field communication module 970, and an RF circuit 910. The computer device 900 may further include one or more sensors 950, for example, an acceleration sensor, an optical sensor, a pressure sensor, and the like. The audio circuit 960 specifically includes a speaker 961, a microphone 962, and the like. For example, the computer device 900 may collect a user's sound through the microphone 962, perform a corresponding operation, and the like.

In some embodiments, there may be one or more processors 980, and the processor 980 and the memory 920 may be coupled or relatively independent.

In some embodiments, the processor 980 in FIG. 9 may be configured to implement functions of the obtaining module 801 and the reading module 802 in FIG. 8.

In some embodiments, the processor 980 in FIG. 9 may be configured to implement the functions corresponding to the foregoing server or terminal device.

A person of ordinary skill in the art may understand that all or some operations for implementing the foregoing embodiments of the present invention may be completed by a program instructing related hardware, the foregoing program may be stored in a computer-readable storage medium, and, the program, when executed, performs operations including the foregoing method embodiments. The storage medium includes any medium that can store program code, such as a removable storage device, a ROM, a RAM, a magnetic disk, or an optical disc.

Alternatively, when the integrated unit of the present invention is implemented in a form of a software functional module and sold or used as an independent product, the integrated unit may be stored in a computer-readable storage medium. Based on such an understanding, the technical solutions in the embodiments of the present invention essentially, or a part contributing to the related art may be implemented in a form of a software product, for example, through a computer program product. The computer program product is stored in a storage medium, and includes several instructions for indicating a computer device to perform all or some of the methods in the embodiments of the present invention. The storage medium includes any medium that can store program code, such as a removable storage device, a ROM, a RAM, a magnetic disk, or an optical disc.

It is clear that a person skilled in the art can make various modifications and variations to this application without departing from the spirit and scope of this application. In this case, if the modifications and variations made to this application fall within the scope of the claims of this application and their equivalent technologies, this application is intended to include these modifications and variations.

What is claimed is:

1. A data processing method, performed by a processing circuit in a computer device, the method comprising:
obtaining an arithmetic operation instruction that indicates to perform an arithmetic operation based on a plurality of floating-point numbers;
reading a first floating-point number, a second floating-point number, and a third floating-point number referred to by the plurality of floating-point numbers in response to the arithmetic operation instruction being a multiply-add operation instruction;
performing a multiplication operation on the first floating-point number and the second floating-point number to obtain a multiplication result;
determining a first exponent difference between an exponent of the multiplication result and an exponent of the third floating-point number;
performing alignment shift on at least one of the third floating-point number or the multiplication result according to an alignment shift amount corresponding to the first exponent difference in response to the first exponent difference being less than or equal to a first shift amount threshold, to obtain a first aligned floating-point number and a first alignment multiplication result;
calculating a first addition result between the first aligned floating-point number and the first alignment multiplication result by using a first adder in the processing circuit, and predicting a normalization shift amount required for the first addition result by using a prediction encoder in the processing circuit; and
performing normalization shift on the first addition result according to the normalization shift amount required for the first addition result to obtain a first normalized result, and obtaining an operation result of the multiply-add operation according to the first normalized result.

2. The method according to claim 1, wherein the performing the multiplication operation on the first floating-point number and the second floating-point number to obtain the multiplication result comprises:
inputting the first floating-point number and the second floating-point number into an encoder of the processing circuit, and performing a multiplication operation on values of bits comprised in a mantissa of the first floating-point number, and a mantissa of the second floating-point number respectively, to obtain corresponding partial products outputted by the encoder;
inputting the obtained partial products into a first carry save adder (CSA) in the processing circuit, and compressing the partial products, to obtain a first carry result and a first original bit result outputted by the first CSA; and
using the obtained first carry result and first original bit result as the multiplication result.

3. The method according to claim 1, wherein the first adder comprises a second CSA and a first full adder, and
wherein the calculating the first addition result between the first aligned floating-point number and the first alignment multiplication result by using the first adder in the processing circuit, and predicting the normalization shift amount required for the first addition result by using the prediction encoder in the processing circuit comprises:
inputting the first aligned floating-point number and the first alignment multiplication result into the second CSA, and compressing the first aligned floating-point number and the first alignment multiplication result, to obtain a first alignment carry result and a first alignment original bit result outputted by the second CSA; and
inputting the obtained first alignment carry result and the first alignment original bit result into the first full adder and the prediction encoder respectively, to obtain the first addition result by using the first full adder, and predict the quantity of specified values comprised before the specified bits in an exponent of the first addition result by using the prediction encoder, to obtain a normalization shift amount required for the first addition result outputted by the prediction encoder.

4. The method according to claim 1, wherein the obtaining the operation result of the multiply-add operation according to the first normalized result comprises:
when the first normalized result is determined to meet a preset floating-point number standard, rounding a mantissa of the first normalized result, to obtain the operation result of the multiply-add operation; and
when the first normalized result is determined to not meet the floating-point number standard, performing correction shift on the first normalized result according to the floating-point number standard, and rounding a mantissa of the first normalized result after the correction shift, to obtain the operation result of the multiply-add operation.

5. The method according to claim 1, further comprising:
performing, in response to the first exponent difference being greater than or equal to a second shift amount threshold, alignment shift on at least one of the third floating-point number or the multiplication result according to an alignment shift amount corresponding to the first exponent difference, to obtain a second aligned floating-point number and a second alignment multiplication result;
calculating a second addition result between the second aligned floating-point number and the second alignment multiplication result by using a second adder in the processing circuit; and
performing normalization shift on the second addition result according to a preset floating-point number standard, to obtain a second normalization shift result, and obtaining the operation result of the multiply-add operation according to the second normalization shift result.

6. The method according to claim 5, wherein the second adder comprises a third CSA and a second full adder, and
wherein the calculating the second addition result between the second aligned floating-point number and the second alignment multiplication result by using the second adder in the processing circuit comprises:
inputting the second aligned floating-point number and the second alignment multiplication result into the third CSA, and compressing the second aligned floating-point number and the second alignment multiplication result, to obtain a second alignment carry result and a second alignment original bit result outputted by the third CSA; and
inputting the obtained second alignment carry result and the second alignment original bit result into the second full adder, to obtain the second addition result by using the second full adder.

7. The method according to claim 1, further comprising:
reading a fourth floating-point number and a fifth floating-point number referred to by the plurality of floating-point numbers in response to the arithmetic operation instruction being an addition operation instruction;
determining a second exponent difference between an exponent of the fourth floating-point number and an exponent of the fifth floating-point number;
performing alignment shift on at least one of the fourth floating-point number or the fifth floating-point number according to an alignment shift amount corresponding to the second exponent difference in response to the second exponent difference being less than or equal to a first shift amount threshold, to obtain a third aligned floating-point number and a fourth aligned floating-point number;
calculating a third addition result of the third aligned floating-point number and the fourth aligned floating-point number by using a first adder in the processing circuit, and predicting a normalization shift amount required for the third addition result by using a prediction encoder in the processing circuit; and
performing normalization shift on the third addition result according to the predicted normalization shift amount required for the third addition result to obtain a third normalized result, and obtaining an operation result of the addition operation according to the third normalized result.

8. The method according to claim 7, further comprising:
performing alignment shift on at least one of the fourth floating-point number or the fifth floating-point number according to an alignment shift amount corresponding to the second exponent difference in response to the second exponent difference being greater than or equal to a second shift amount threshold, to obtain a fifth aligned floating-point number and a sixth aligned floating-point number;
calculating a fourth addition result between the fifth aligned floating-point number and the sixth aligned floating-point number by using a second adder in the processing circuit; and
performing normalization shift on the fourth addition result according to a preset floating-point number standard, to obtain a fourth normalization shift result, and obtaining an operation result of the addition operation according to the fourth normalization shift result.

9. The method according to claim 1, further comprising:
reading a sixth floating-point number and a seventh floating-point number referred to by the plurality of floating-point numbers in response to the arithmetic operation instruction being a multiplication operation instruction; and
performing a multiplication operation on the sixth floating-point number and the seventh floating-point number, to obtain an operation result of the multiplication operation.

10. The method according to claim 9, wherein the performing the multiplication operation on the sixth floating-point number and the seventh floating-point number, to obtain the operation result of the multiplication operation comprises:
inputting the sixth floating-point number and the seventh floating-point number into an encoder in the processing circuit, and performing a multiplication operation on values of bits comprised in a mantissa of the sixth floating-point number, and a mantissa of the seventh floating-point number respectively, to obtain corresponding partial products outputted by the encoder;
inputting the obtained partial products into a first CSA in the processing circuit, and compressing the partial products, to obtain a second carry result and a second original bit result outputted by the first CSA;
inputting the obtained second carry result and second original bit result into a third full adder of the processing circuit, to obtain an initial multiplication result outputted by the third full adder; and
performing normalization shift on the initial multiplication result according to a preset floating-point number standard, to obtain an operation result of the multiplication operation.

11. A data processing apparatus comprising:
a memory storing a plurality of instructions; and
a processor configured to execute the plurality of instructions, wherein upon execution of the plurality of instructions, the processor is configured to:
obtain an arithmetic operation instruction that indicates to perform an arithmetic operation based on a plurality of floating-point numbers;
read a first floating-point number, a second floating-point number, and a third floating-point number referred to by the plurality of floating-point numbers in response to the arithmetic operation instruction being a multiply-add operation instruction;
perform a multiplication operation on the first floating-point number and the second floating-point number to obtain a multiplication result;
determine a first exponent difference between an exponent of the multiplication result and an exponent of the third floating-point number;
perform alignment shift on at least one of the third floating-point number or the multiplication result according to an alignment shift amount corresponding to the first exponent difference in response to the first exponent difference being less than or equal to a first shift amount threshold, to obtain a first aligned floating-point number and a first alignment multiplication result;
calculate a first addition result between the first aligned floating-point number and the first alignment multiplication result by using a first adder in the processing circuit, and predict a normalization shift amount required for the first addition result by using a prediction encoder in the processing circuit; and
perform normalization shift on the first addition result according to the normalization shift amount required for the first addition result to obtain a first normalized result, and obtain an operation result of the multiply-add operation according to the first normalized result.

12. The apparatus according to claim 11, wherein in order to perform the multiplication operation on the first floating-point number and the second floating-point number to obtain the multiplication result, the processor, upon execution of the plurality of instructions, is configured to:
input the first floating-point number and the second floating-point number into an encoder of the processing circuit, and perform a multiplication operation on values of bits comprised in a mantissa of the first floating-point number, and a mantissa of the second floating-point number respectively, to obtain corresponding partial products outputted by the encoder;
input the obtained partial products into a first carry save adder (CSA) in the processing circuit, and compress the partial products, to obtain a first carry result and a first original bit result outputted by the first CSA; and
use the obtained first carry result and first original bit result as the multiplication result.

13. The apparatus according to claim 11, wherein the first adder comprises a second CSA and a first full adder, and
wherein in order to calculate the first addition result between the first aligned floating-point number and the first alignment multiplication result by using the first adder in the processing circuit, and predict the normalization shift amount required for the first addition result by using the prediction encoder in the processing circuit, the processor, upon execution of the plurality of instructions, is configured to:
input the first aligned floating-point number and the first alignment multiplication result into the second CSA, and compress the first aligned floating-point number and the first alignment multiplication result, to obtain a first alignment carry result and a first alignment original bit result outputted by the second CSA; and
input the obtained first alignment carry result and the first alignment original bit result into the first full adder and the prediction encoder respectively, to obtain the first addition result by using the first full adder, and predict the quantity of specified values comprised before the specified bits in an exponent of the first addition result by using the prediction encoder, to obtain a normalization shift amount required for the first addition result outputted by the prediction encoder.

14. The apparatus according to claim 11, wherein in order to obtain the operation result of the multiply-add operation according to the first normalized result, the processor, upon execution of the plurality of instructions, is configured to:
when the first normalized result is determined to meet a preset floating-point number standard, round a mantissa of the first normalized result, to obtain the operation result of the multiply-add operation; and
when the first normalized result is determined to not meet the floating-point number standard, perform correction shift on the first normalized result according to the floating-point number standard, and round a mantissa of the first normalized result after the correction shift, to obtain the operation result of the multiply-add operation.

15. The apparatus according to claim 11, wherein the processor, upon execution of the plurality of instructions, is further configured to:
perform, in response to the first exponent difference being greater than or equal to a second shift amount threshold, alignment shift on at least one of the third floating-point number or the multiplication result according to an alignment shift amount corresponding to the first exponent difference, to obtain a second aligned floating-point number and a second alignment multiplication result;
calculate a second addition result between the second aligned floating-point number and the second alignment multiplication result by using a second adder in the processing circuit; and
perform normalization shift on the second addition result according to a preset floating-point number standard, to obtain a second normalization shift result, and obtain the operation result of the multiply-add operation according to the second normalization shift result.

16. A non-transitory computer-readable storage medium storing a plurality of instructions executable by a processor, wherein when executed by the processor, the plurality of instructions is configured to cause the processor to:
obtain an arithmetic operation instruction that indicates to perform an arithmetic operation based on a plurality of floating-point numbers;
read a first floating-point number, a second floating-point number, and a third floating-point number referred to by the plurality of floating-point numbers in response to the arithmetic operation instruction being a multiply-add operation instruction;
perform a multiplication operation on the first floating-point number and the second floating-point number to obtain a multiplication result;
determine a first exponent difference between an exponent of the multiplication result and an exponent of the third floating-point number;
perform alignment shift on at least one of the third floating-point number or the multiplication result according to an alignment shift amount corresponding to the first exponent difference in response to the first exponent difference being less than or equal to a first shift amount threshold, to obtain a first aligned floating-point number and a first alignment multiplication result;
calculate a first addition result between the first aligned floating-point number and the first alignment multiplication result by using a first adder in the processing circuit, and predict a normalization shift amount required for the first addition result by using a prediction encoder in the processing circuit; and
perform normalization shift on the first addition result according to the normalization shift amount required for the first addition result to obtain a first normalized result, and obtain an operation result of the multiply-add operation according to the first normalized result.

17. The non-transitory computer-readable storage medium according to claim 16, wherein in order to cause the processor to perform the multiplication operation on the first floating-point number and the second floating-point number to obtain the multiplication result, the plurality of instructions, when executed by the processor, is configured to cause the processor to:
input the first floating-point number and the second floating-point number into an encoder of the processing circuit, and perform a multiplication operation on values of bits comprised in a mantissa of the first floating-point number, and a mantissa of the second floating-point number respectively, to obtain corresponding partial products outputted by the encoder;
input the obtained partial products into a first carry save adder (CSA) in the processing circuit, and compress the partial products, to obtain a first carry result and a first original bit result outputted by the first CSA; and
use the obtained first carry result and first original bit result as the multiplication result.

18. The non-transitory computer-readable storage instructions according to claim 16, wherein the first adder comprises a second CSA and a first full adder, and
wherein in order to cause the processor to calculate the first addition result between the first aligned floating-point number and the first alignment multiplication result by using the first adder in the processing circuit, and predict the normalization shift amount required for the first addition result by using the prediction encoder in the processing circuit, the plurality of instructions, when executed by the processor, is configured to cause the processor to:
input the first aligned floating-point number and the first alignment multiplication result into the second CSA, and compress the first aligned floating-point number and the first alignment multiplication result, to obtain a first alignment carry result and a first alignment original bit result outputted by the second CSA; and
input the obtained first alignment carry result and the first alignment original bit result into the first full adder and the prediction encoder respectively, to obtain the first addition result by using the first full adder, and predict the quantity of specified values comprised before the specified bits in an exponent of the first addition result by using the prediction encoder, to obtain a normalization shift amount required for the first addition result outputted by the prediction encoder.

19. The apparatus according to claim 16, wherein the plurality of instructions, when executed by the processor, is further configured to cause the processor to:
read a fourth floating-point number and a fifth floating-point number referred to by the plurality of floating-point numbers in response to the arithmetic operation instruction being an addition operation instruction;
determine a second exponent difference between an exponent of the fourth floating-point number and an exponent of the fifth floating-point number;
perform alignment shift on at least one of the fourth floating-point number or the fifth floating-point number according to an alignment shift amount corresponding to the second exponent difference in response to the second exponent difference being less than or equal to a first shift amount threshold, to obtain a third aligned floating-point number and a fourth aligned floating-point number;
calculate a third addition result of the third aligned floating-point number and the fourth aligned floating-point number by using a first adder in the processing circuit, and predict a normalization shift amount required for the third addition result by using a prediction encoder in the processing circuit; and
perform normalization shift on the third addition result according to the predicted normalization shift amount required for the third addition result to obtain a third normalized result, and obtain an operation result of the addition operation according to the third normalized result.

20. The non-transitory computer-readable storage medium according to claim 16, wherein the plurality of instructions, when executed by the processor, is further configured to cause the processor to:
read a sixth floating-point number and a seventh floating-point number referred to by the plurality of floating-point numbers in response to the arithmetic operation instruction being a multiplication operation instruction; and
perform a multiplication operation on the sixth floating-point number and the seventh floating-point number, to obtain an operation result of the multiplication operation.
